(19) United States
(12) Patent Application Publication
(10) Pub. No.: US 2023/0305908 A1
(43) Pub. Date: Sep. 28, 2023

(54) HARDWARE EVENT MESSAGES

(71) Applicant: Hewlett-Packard Development Company, L.P., Spring, TX (US)

(72) Inventors: Byron A. Alcorn, Fort Collins, CO (US); Patrick S. Anderson, Fort Collins, CO (US); Peter Seiler, Fort Collins, CO (US); Joseph-Jonathan Salzano, Fort Collins, CO (US); Vinh Nguyen, Fort Collins, CO (US); Jeffrey Edward Leaming, Fort Collins, CO (US); Michael Allan Miller, Fort Collins, CO (US)

(73) Assignee: Hewlett-Packard Development Company, L.P., Spring, TX (US)

(21) Appl. No.: 18/006,633

(22) PCT Filed: Jul. 31, 2020
(86) PCT No.: PCT/US2020/044459

§ 371 Date: Jan. 24, 2023

(51) Int. Cl. G06F 9/54

(52) U.S. Cl. CPC G06F 9/546; G06F 9/542

(57) ABSTRACT

In some examples, a computing device can include a memory resource storing instructions to cause a processing resource to detect a hardware event associated with the computing device, generate an alert standard format (ASF) message associated with the hardware event, and transmit the ASF message to a microcontroller to cause the microcontroller to transmit the ASF message to an external computing device.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry or otherwise bring with the computing device with while in a mobile setting.

### BRIEF DESCRIPTION OF THE DRAWINGS

FIG. 1 is an example of a computing device for hardware event messages.

FIG. 2 illustrates an example of a computing device for hardware event messages.

FIG. 3 illustrates a block diagram of an example system for hardware event messages.

FIG. 4 illustrates an example of a method for hardware event messages.

### DETAILED DESCRIPTION

A user may utilize a computing device for various purposes. As used herein, the term “computing device” refers to an electronic system having a processing resource, a memory resource, and/or an application-specific integrated circuit (ASIC) that can process information. Examples of computing devices can include, for instance, a laptop computer, a notebook computer, a desktop computer, a server, a networking device (e.g., router, switch, etc.), and/or a mobile device (e.g., a smart phone, tablet, personal digital assistant, smart glasses, a wrist-worn device, etc.), among other types of computing devices. As used herein, a mobile device can include devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

A computing device may be included as part of a computing device system. Such computing systems may include monitoring tools. The monitoring tools may be utilized to retrieve information regarding the health, status, and/or errors of a computing device (or computing devices) included in the computing device system. Such information can be transmitted to an external computing device for review by, for instance, a user such as an administrator or other user.

One mechanism to transmit information about a computing device is the alert standard format (ASF) message. As used herein, the term “ASF” refers to a standard for remote monitoring, management, and/or control of computing systems in both operating system (OS)-present and/or OS-absent environments. As used herein, the term “operating system” refers to a management application that manages computing device hardware, computing resources, and provides services for applications. For example, the operating system (e.g., OS) can manage hardware such as a motherboard, power supply, drives (e.g., floppy, optical (compact disc read-only memory (CD-ROM), compact disc-rewritable (CD-RW), digital video disc read-only memory (DVD-ROM), etc.)), hard disk, video card, sound card, peripheral devices (e.g., keyboard, touchpad, mouse, etc.), among other hardware components. An ASF message can include information about a computing device according to the ASF standard.

Monitoring, management, and/or control of computing systems according to ASF can allow for hardware monitoring of computing device(s). For example, a computing device can be monitored and/or controlled via the ASF standard in order to minimize on-site maintenance of the computing device by an administrator, which can allow for an increase in computing device availability and/or performance to a user of the computing device.

However, ASF messaging is typically limited in capability. For example, ASF messaging can be utilized to monitor for OS boot failure and/or OS hang (e.g., the OS ceases to respond to inputs). Accordingly, if additional alerting capability is desired, an additional monitoring service has to be included. This can result in multiple alerting systems at once, which can add complexity.

Hardware event messages can utilize an ASF message to transmit information about a hardware event. For example, information about a hardware event can be transmitted to, for example, an external computing device so that a user (e.g., such as an administrator or other user) can monitor, manage, and/or control the computing device in response to a hardware event. Transmission of information in response to a hardware event utilizing an ASF message can allow for a single alerting service, eliminating complexity associated with multiple alerting services, and utilizes existing computing device infrastructure such as existing hardware and OS capabilities.

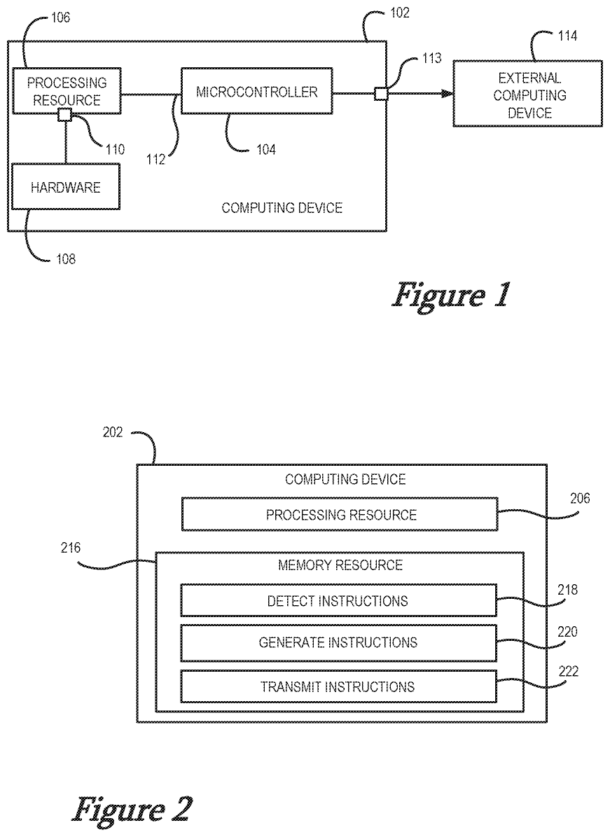

FIG. 1 is an example of a computing device 102 for hardware event messages. The computing device 102 can include a processing resource 106, hardware 108, and a microcontroller 104.

As illustrated in FIG. 1, the computing device 102 can include hardware 108. As used herein, the term “hardware” refers to devices comprising a computing system. For example, hardware 108 can include a motherboard, power supply, drives (e.g., floppy, optical (CD-ROM, CD-RW, DVD-ROM, etc.)), hard disk, video card, sound card, peripheral devices (e.g., keyboard, touchpad, mouse, etc.), among other hardware components.

The processing resource 106 can detect a hardware event associated with the computing device 102. As used herein, the term “hardware event” refers to an occurrence of an action. For example, a hardware event can be a state change in the hardware 108. For example, the hardware 108 may include a redundant array of independent disks (RAID) hard drive configuration. That is, the hardware 108 may include three hard disks setup in a RAID configuration. In an example, one of the three hard disks may fail. The processing resource 106 can detect the failed hard disk as a detected hardware event.

Although the hardware event is described above as being a failure of a hard disk in a RAID configuration, examples of the disclosure are not so limited. For example, the hardware event can be an event that does not cause an OS of the computing device (e.g., not illustrated in FIG. 1) to shut down. As used herein, the term “shut down” refers to a state in which applications managed by an OS, as well as the OS itself, are closed. For example, an OS shutdown can include a state in which the OS is no longer managing or providing services for applications or to the OS itself. Accordingly, hardware events may include a power supply failure (e.g., in an instance in which computing device 102 includes more than one power supply), a fan failure, a thermal event (e.g., a component is detected to be abnormally hot), an input/output (I/O) resource becoming unresponsive (e.g., a “Yellow Bang” on an I/O resource in the OS, such as a Universal Serial Bus (USB) port for example) among other types of hardware events (e.g., that do not cause an OS of the computing device 102) to shut down.

The processing resource 106 can detect the hardware event via a general-purpose input/output (GPIO) pin 110. As used herein, the term “GPIO pin” refers to a pin on an integrated circuit or electronic circuit board whose behavior is defined and controllable. For example, the processing resource 106 can detect the hardware event via the GPIO pin 110 when the GPIO pin 110 is in a particular state based on a received signal, as is further described herein.

In some examples, the GPIO pin 110 can be in a high state. As used herein, the term “high state” refers to a condition in which a GPIO pin is at a first predefined voltage. For example, the GPIO pin 110 can be at a voltage of 3.3V, which can correspond to the GPIO pin 110 being in a high state. The GPIO pin 110 may be at the voltage of 3.3V as a result of receiving a signal from the hardware 108, among other examples. Further, although the GPIO pin 110 is described as being in a high state at a voltage of 3.3V, examples of the disclosure are not so limited. For instance, the GPIO pin 110 can be in a high state at any other defined voltage.

When the GPIO pin 110 is in the high state, the processing resource 106 can determine that no hardware event has occurred. Continuing with the example from above, if the three hard disks in the RAID configuration are operating, the GPIO pin 110 can be in the high state as a result of a signal being received from the three hard disks in the RAID configuration. As a result of the GPIO pin 110 being in the high state, the processing resource 106 can determine that no hardware event has occurred.

In some examples, the GPIO pin 110 can be in a low state. As used herein, the term “low state” refers to a condition in which a GPIO pin is at a second predefined voltage. For example, the GPIO pin 110 can be at a voltage of 0V, which can correspond to the GPIO pin 110 being in a low state. The GPI© pin 110 may be at the voltage of 0V as a result of not receiving a signal from the hardware 108, among other examples.

When the GPIO pin 110 is in the low state, the processing resource 106 can determine that a hardware event has occurred. Continuing with the example from above, if a hard disk of the three hard disks in the RAID configuration has failed, the GPIO pin 110 can be in the low state as a result of a signal not being received from the three hard disks in the RAID configuration. As a result of the GPIO pin 110 being in the low state, the processing resource 106 can determine that a hardware event has occurred.

When the hardware event occurs, the processing resource 106 can generate an ASF message associated with the hardware event. As described above, an ASF message can include information about a computing device according to the ASF standard. The ASF standard can support certain types of alerts, including initial firmware timeout, polled legacy sensors, polled ASF sensors, and/or pushed events. While pushed events can allow for events to be pushed to the microcontroller 104, the structure of the ASF message can prevent some types of messages from being sent because of the structure of the ASF message. Accordingly, hardware event messages according to the disclosure can allow for generation of an ASF message according to the ASF standard but including a message structure that can be utilized for additional hardware event types as compared with previous approaches, as is further described herein.

An ASF message can include an event type, an event sensor type, and an event offset. The event type, the event sensor type, and the event offset can be fields that are defined by the Intelligent Platform Management Interface (IPMI) platform event trap (PET) specification. As used herein, the term “event sensor type” refers to field for a logical entity that can detect events and can include a sensor type code to indicate the type of events a sensor is monitoring. The event sensor type can include a sensor type code to encode the sensor type. For example, the sensor type code “07H” can be for a processor, “08h” can be for a power supply, “0Ch” can be for memory, “0Fh” can be for firmware, among other examples.

As used herein, the term “event type” refers to a field for a type of trigger for the event and can include a string to indicate what type of transition or state triggered an event. For example, an event type can indicate the type of trigger for an event (e.g., a threshold being exceeded, a state being asserted, etc.). An event type can further include different ranges to encode the event type. For example, the ranges defined by “00-0Bh” can be generic to be used with any type of sensor, the range indicated by “6Fh” can be a sensor specific event type, the range indicated by “70h-7Fh” can be OEM, etc.

As used herein, the term “event offset” refers to a field that indicates which particular event has occurred for a given event type or event sensor type. For example, in an instance in which a power supply failure is detected, a sensor type code can be “08h” and the sensor-specific offset can be “01h” as per the IPMI PET specification.

As described above, the processing resource 106 can generate an ASF message associated with a hardware event, where the ASF message can include an event type, an event sensor type, and an event offset. The ASF message can be generated such that when an event type is a sensor specific event, the event type can include one of the event sensor type offsets, else the event offset is an offset associated with a generic sensor type. That is, the event sensor type can be whatever appropriate event sensor type should be. When the event type is not a sensor specific event, the event offset can be an offset associated with a generic sensor type. For example, if the event type is “0x6F”, then the event offset is one of the event sensor type offsets. If the event type is not “0x6F”, the event offset is the offset associated with the generic sensor type. This ASF message structure can allow for a basic input/output system (BIOS) of the computing device 102 (event sensor type “0x0F”) and an OS of the computing device 102 (event sensor type “0x12”) to monitor the hardware 108.

For example, the computing device 102 may include two power supplies. A hardware event may include failure of one of the power supplies. Accordingly, the processing resource 106 can detect the hardware event and generate an ASF message including an event sensor type “0x0F” indicating the BIOS of the computing device 102 detected a failed power supply (event type “0xB”, event offset “0x1” indicating redundancy in the power supplies for the computing device 102 is now lost).

The processing resource 106 can generate the ASF message associated with the hardware event while the OS of the computing device 102 is running. As used herein, the term “running” refers to a state in which a computing device is executing instructions of an OS. For example, utilizing the ASF message structure described above, an ASF message can be generated while the OS of the computing device 102 is running.

The processing resource 106 can transmit the ASF message to a microcontroller 104. As used herein, the term “microcontroller” refers to an embedded integrated circuit (IC) chip to perform tasks while the computing device is in a sleep mode, during a boot process of the computing device, and/or when the computing device is running. The microcontroller 104 can be an embedded microcontroller in communication with the processing resource 106. In some examples, the microcontroller 104 can include a power state that is independent of the host power state, allowing the microcontroller 104 to function when other components of the computing device 102 are in a sleep state.

The processing resource 106 can transmit the ASF message to the microcontroller 104 via a host embedded controller interface (HECI) bus 112. As used herein, the term “HECI bus” refers to a communication system that transfers data between components inside a computing device to allow an OS of the computing device to communicate with a microcontroller of the computing device. For example, the HECI bus 112 can be a bi-directional, variable data-rate bus that can allow the processing resource to transmit an ASF message to the microcontroller 104.

The microcontroller 104 can transmit the ASF message to an external computing device 114. For example, the ASF message can be transmitted to the external computing device 114 so that a user, such as an administrator, can review the ASF message in order to remotely monitor, manage, or control the computing device 102. For instance, the administrator can review the ASF message to determine that a redundant power supply of the computing device 102 has failed, and can order maintenance for the computing device 102, etc.

The microcontroller 104 can transmit the ASF message to the external computing device 114 via a network interface 113. As used herein, the term “network interface” refers to a software and/or hardware interface to enable communication between two computing devices. For example, the network interface 113 can be a port, a network interface controller, a network socket, etc.

The microcontroller 104 can transmit the ASF message to the external computing device 114 via the network interface 113 via a wired or wireless network connection. The wired or wireless network connection can be a network relationship that connects the computing device 102 to the external computing device 114. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC). Bluetooth, Worldwide Interoperability for Microwave Access (WiMAX), infrared (IR) communication, Public Switched Telephone Network (PSTN), radio waves, and/or the Internet, among other types of network relationships.

The microcontroller 104 can log the hardware event in the order in which it was received. For example, the processing resource 106 may detect a first hardware event at a first time and a second hardware event at a second time, where the first time occurs before the second time. The processing resource 106 can generate a first ASF message and transmit the first ASF message to the microcontroller 104 and generate a second ASF message and transmit the second ASF message to the microcontroller 104, where the microcontroller 104 be logging the first ASF message and then the second ASF message. Accordingly, if multiple hardware events occur, a user may review the logged hardware events in the order in which they were received, which can simplify analysis and/or debugging.

Hardware event messages according to the disclosure can allow for an alerting service utilizing ASF messaging when a hardware event occurs. Such ASF messages can be transmitted to an external computing device allowing for monitoring, management, and/or control of a computing device utilizing existing computing device infrastructure. Utilizing a single alerting service can eliminate complexity associated with multiple alerting services in order to better provide information about the health of a computing device, status of components of the computing device, and/or hardware events as compared with previous approaches.

FIG. 2 illustrates an example of a computing device 202 for hardware event messages. Although not illustrated in FIG. 2, the computing device 202 may include a processor and a non-transitory machine-readable storage medium. Although the following descriptions refer to a single processor and a single machine-readable storage medium, the descriptions may also apply to a system with multiple processors and multiple machine-readable storage mediums. In such examples, the computing device 202 may be distributed across multiple non-transitory machine-readable storage mediums and across multiple processors. Put another way, the instructions executed by the computing device 202 may be stored across multiple machine-readable storage mediums and executed across multiple processors, such as in a distributed or virtual computing environment.

Processing resource 206 may be a central processing unit (CPU), a semiconductor-based microprocessor, and/or other hardware devices suitable for retrieval and execution of machine-readable instructions 218, 220, 222 stored in a memory resource 216. Processing resource 206 may fetch, decode, and execute instructions 218, 220, 222. As an alternative or in addition to retrieving and executing instructions 218, 220, 222, processing resource 206 may include a plurality of electronic circuits that include electronic components for performing the functionality of instructions 218, 220, 222.

Memory resource 216 may be any electronic, magnetic, optical, or other physical storage device that stores executable instructions 218, 220, 222 and/or data. Thus, memory resource 216 may be, for example, Random-Access Memory (RAM), an Electrically-Erasable Programmable Read-Only Memory (EEPROM), a storage drive, an optical disc, and the like. Memory resource 216 may be disposed within computing device 202, as shown in FIG. 2. Additionally, memory resource 216 may be a portable, external or remote storage medium, for example, that causes computing device 202 to download the instructions 218, 220, 222 from the portable/external/remote storage medium.

The computing device 202 may include instructions 218 stored in the memory resource 216 and executable by the processing resource 206 to detect a hardware event associated with the computing device 202. For example, the hardware event can be a state change, such as a failure of a component or a device of the computing device 202, among other examples. The computing device 202 can detect the hardware event via a GPIO pin.

The computing device 202 may include instructions 220 stored in the memory resource 216 and executable by the processing resource 206 to generate an ASF message associated with the hardware event. For example, the ASF message can include information about a computing device according to the ASF standard. The ASF message can include an event type, an event sensor type, and an event offset.

The computing device 202 may include instructions 222 stored in the memory resource 216 and executable by the processing resource 206 to transmit the ASF message to a microcontroller to cause the microcontroller to transmit the ASF message to an external computing device. The computing device 202 can transmit the ASF message to the microcontroller via a HECI bus. The microcontroller can then transmit the ASF message to an external computing device.

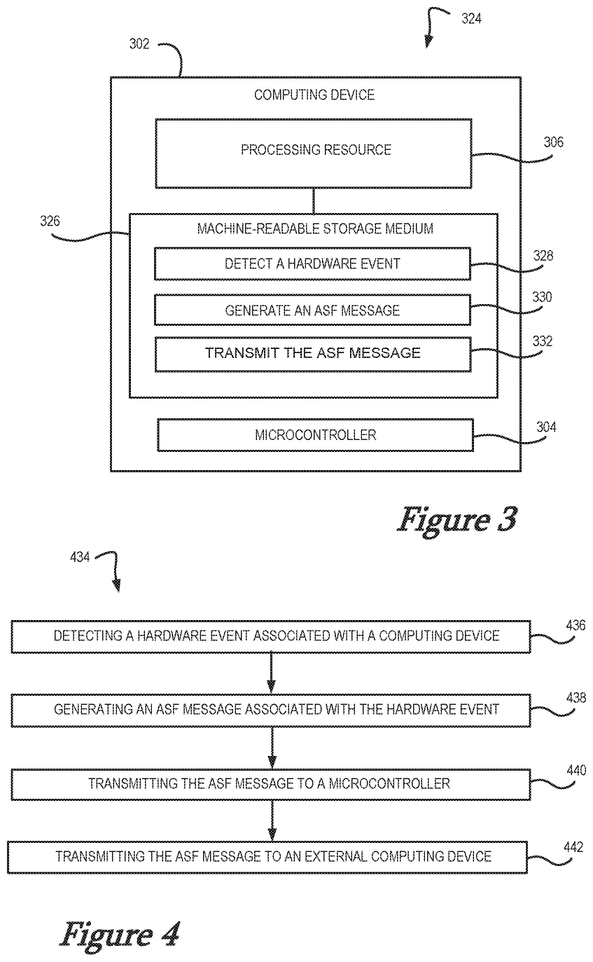

FIG. 3 illustrates a block diagram of an example system 324 for hardware event messages. In the example of FIG. 3, system 324 includes a computing device 302 having a processing resource 306 and a non-transitory machine-readable storage medium 326. Although the following descriptions refer to a single processor resource and a single machine-readable storage medium, the descriptions are applicable to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 306 may be a central processing unit (CPU), microprocessor, and/or other hardware device suitable for retrieval and execution of instructions stored in machine-readable storage medium 326. In the particular example shown in FIG. 3, processing resource 306 may receive, determine, and send instructions 328, 330, and 332, As an alternative or in addition to retrieving and executing instructions, processing resource 306 may include an electronic circuit comprising a number of electronic components for performing the operations of the instructions in machine-readable storage medium 326. With respect to the executable instruction representations or boxes described and shown herein, it should be understood that part or all of the executable instructions and/or electronic circuits included within one box may be included in a different box shown in the figures or in a different box not shown.

Machine-readable storage medium 326 may be any electronic, magnetic, optical, or other physical storage device that stores executable instructions. The executable instructions may be “installed” on the system 324 illustrated in FIG. 3. Machine-readable storage medium 326 may be a portable, external or remote storage medium, for example, that allows the system 324 to download the instructions from the portable/external/remote storage medium. In this situation, the executable instructions may be part of an “installation package”.

Detect a hardware event instructions 328, when executed by a processor such as processing resource 306, may cause system 324 to detect a hardware event associated with a computing device 302. For example, the hardware event can be a state change, such as a failure of a component or device of the computing device 302, among other examples. The computing device 302 can detect the hardware event via a GPIO pin.

Generate an ASF message instructions 330, when executed by a processor such as processing resource 306, may cause system 324 to generate an ASF message associated with the hardware event. For example, the ASF message can include information about a computing device according to the ASF standard. The ASF message can include an event type, an event sensor type, and an event offset. The system 324 can generate the ASF message while the OS of the computing device 302 is running.

Transmit the ASF message instructions 332, when executed by a processor such as processing resource 306, may cause system 324 to transmit the ASF message to a microcontroller 304. The computing device 302 can transmit the ASF message to the microcontroller 304 via a HECI bus. The microcontroller 304 can then transmit the ASF message to an external computing device.

FIG. 4 illustrates an example of a method 434 for hardware event messages. For example, method 434 can be performed by a computing device (e.g., computing device 102, 202, 302, previously described in connection with FIGS. 1-3, respectively).

At 436, the method 434 includes detecting a hardware event associated with a computing device. The hardware event can be a state change, such as a failure of a component or device of the computing device, among other examples. The computing device can detect the hardware event via a GPIO pin.

At 438, the method 434 includes generating an ASF message associated with the hardware event. The ASF message can include information about a computing device according to the ASF standard. The ASF message can include an event type, an event sensor type, and an event offset. The computing device can generate the ASF message while the OS of the computing device 302 is running.

At 440, the method 434 includes transmitting the ASF message to a microcontroller. The OS of the computing device can transmit the ASF message to the microcontroller via a HECI bus while the OS is running.

At 442, the method 434 includes transmitting, by the microcontroller, the ASF message to an external computing device. The microcontroller can transmit the ASF message to an external computing device via a network interface.

In the foregoing detailed description, reference is made to the accompanying drawings that form a part hereof, and in which is shown by way of illustration how examples may be practiced. These examples are described in sufficient detail to enable those of ordinary skill in the art to practice the examples described herein, and it is to be understood that other examples may be utilized and that process, electrical, and/or structural changes may be made without departing from the scope of the specification. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples. In addition, the proportion and the relative scale of the elements provided in the figures are intended to illustrate the examples described herein and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications and use of the system and method. Since many examples can be made without departing from the spirit and scope of the system and method, this specification merely sets forth some of the many possible example configurations and implementations.

What is claimed is:

1. A computing device, comprising:
a processing resource; and
a non-transitory memory resource storing machine-readable instructions to cause the processing resource to:
detect a hardware event associated with the computing device;
generate an alert standard format (ASF) message associated with the hardware event; and
transmit the ASF message to a microcontroller to cause the microcontroller to transmit the ASF message to an external computing device.

2. The computing device of claim 1, including instructions to cause the processing resource to generate and transmit the ASF message while an operating system (OS) of the computing device is running.

3. The computing device of claim 1, including instructions to cause the processing resource to transmit the ASF message to the microcontroller via a host embedded controller interface (HECI) bus.

4. The computing device of claim 1, including instructions to cause the processing resource to detect the hardware event via a general-purpose input/output (GPIO) pin.

5. The computing device of claim 4, wherein in response to the GPIO pin being in a high state, the processing resource is to determine no hardware event has occurred.

6. The computing device of claim 4, wherein in response to the GPIO pin being in a low state, the processing resource is to detect the hardware event.

7. The computing device of claim 1, wherein the hardware event includes an event that does not cause an operating system (OS) of the computing device to shut down.

8. The computing device of claim 1, wherein the microcontroller is included in the computing device.

9. A non-transitory machine-readable medium including instructions that when executed cause a processing resource to:
detect a hardware event associated with a computing device;
generate an alert standard format (ASF) message associated with the hardware event while an operating system (OS) of the computing device is running; and
transmit the ASF message to a microcontroller while the OS is running to cause the microcontroller to transmit the ASF message to an external computing device.

10. The medium of claim 9, including instructions to cause the processing resource to generate the ASF message including an event type, an event sensor type, and an event offset.

11. The medium of claim 10, wherein when the event type is a sensor specific event, the event type includes an event sensor type offset.

12. The medium of claim 10, wherein when the event type is not a sensor specific event, the event offset is an offset associated with a generic sensor type.

13. A method, comprising:
detecting, by a computing device, a hardware event associated with the computing device;
generating, by the computing device, an alert standard format (ASF) message associated with the hardware event while an operating system (OS) of the computing device is running;
transmitting, by the OS, the ASF message to a microcontroller of the computing device via a host embedded controller (HECI) bus while the OS is running; and
transmitting, by the microcontroller, the ASF message to an external computing device.

14. The method of claim 13, wherein the method includes logging, by the microcontroller, the hardware event among a plurality of hardware events in an order in which the hardware event was received relative to the plurality of hardware events.

15. The method of claim 13, wherein the method includes transmitting, by the microcontroller, the ASF message to the external computing device via a network interface.
